(19) United States
(12) Patent Application Publication
(10) Pub. No.: US 2026/0286551 A1
(43) Pub. Date: Sep. 24, 2026

(54) ELECTRODE FOR GASEOUS EVOLUTION IN ELECTROLYTIC PROCESS

(71) Applicant: INDUSTRIE DE NORA S.P.A., Milan (IT)

(72) Inventors: Alice CALDERARA, Milan (IT); Stefania MORA, Milan (IT); Matteo FIASCHI, Milan (IT)

(21) Appl. No.: 19/474,237

(22) PCT Filed: Apr. 25, 2024
(86) PCT No.: PCT/EP2024/061380

§ 371 Date: Oct. 10, 2025

(30) Foreign Application Priority Data
Apr. 27, 2023 (IT) 102023000008286

(51) Int. Cl. C25B 11/053; C23C 28/02; C25B 1/04; C25B 11/061; C25B 13/00

(52) U.S. Cl. CPC C25B 11/053; C23C 28/023; C25B 1/04; C25B 11/061; C25B 13/00

(57) ABSTRACT

An electrode and in particular to an electrode suitable for gas evolution comprising a metal substrate and a catalytic coating. Such electrode can be used as an anode for the development of oxygen in electrolytic processes such as, for example, in the alkaline electrolysis of water.

### SCOPE OF THE INVENTION

The present invention relates to an electrode and in particular to an electrode suitable for use for gaseous evolution comprising a metal substrate and a catalytic coating. This electrode can be used as an anode for the evolution of oxygen in electrolytic processes such as, for example, in the alkaline water electrolysis.

### BACKGROUND OF THE INVENTION

The field of the invention concerns the preparation of a catalytic coating for electrodes used in the alkaline water electrolysis for hydrogen production, wherein such coating is applied to a metal substrate.

In recent decades, global carbon dioxide emissions have reached increasingly higher values with consequent negative effects; conscious use of resources and attention to their environmental impact are the foundations for an effective and efficient energy transition. In this context, hydrogen plays a key role and represents the most current solution that may give a great contribution to the energy transition as it has the potential to allow part of the industrial sector to be decarbonized; in particular, the so-called energy-intensive sectors such as, for example, refineries and steel industries. Finally, hydrogen can contribute significantly to sustainable mobility.

Hydrogen is the most abundant element in nature and in its free state it is found in the gaseous stage; it is not directly a source of energy, but represents a so-called energy carrier, namely, it can be considered as a means that allows the storage of energy which can be supplied later. Indeed, hydrogen can be stored and used in various sectors, such as transport, or to produce heat for industrial use, up to its introduction into gas transport and distribution networks.

Today, hydrogen is already produced and used, but it is mainly produced by processes that generate significant quantities of carbon dioxide emissions such as, for example, methane reforming process or coal gasification.

The only hydrogen produced that is considered sustainable, since it avoids carbon dioxide emissions into the atmosphere in the production process, is known as green or renewable hydrogen, and is obtained through the electrolysis of aqueous solutions in electrochemical cells powered by electricity produced from renewable sources, such as photovoltaic, hydroelectric, geothermal or wind power.

There are several types of electrolysis processes of aqueous solutions that can be used to generate hydrogen, such as alkaline electrolysis, proton exchange membrane electrolysis, and electrolysis through solid oxide electrolyzers. Proton exchange membrane electrolysis and alkaline electrolysis are more commonly used, with the latter appearing to be in a more advanced state of development and better suited for large-scale implementation.

In the electrolysis of aqueous solutions, an electrical power source is connected to two electrodes, which are placed in a solution; in the electrolysis process the splitting of water molecules into hydrogen and oxygen occurs. It consists of two half-reactions, the oxygen evolution reaction which takes place at the anode and the hydrogen evolution reaction which takes place at the cathode. The hydrogen evolution reaction is a reduction reaction wherein electrons from the cathode are passed to hydrogen cations to form hydrogen gas, while the oxygen evolution reaction is an oxidation reaction wherein electrons go to the anode and oxygen is generated.

The main challenge to realize these two half-reactions is to overcome their slow kinetics. In fact, the kinetic complexities exhibited by these two half-reactions require an excess in cell voltage beyond their thermodynamic potential in order to obtain a process with high efficiency.

Furthermore, recent advances in the electrolysis of aqueous solutions have led the process to operate at high current densities. Additionally, renewable energy sources are often used to provide electrical power to perform electrolysis of aqueous solutions. The use of high current densities, combined with the intermittent nature of the renewable energies, can cause rapid deterioration of the electrodes. Therefore, there is the need to have more durable electrodes that can maintain good performances even under high current density conditions with numerous power interruptions. In particular, an anode with low oxygen overpotential that is not susceptible to degradation due to high current density and shutdowns is required.

In most electrolysis processes, the cost for producing the desired product is largely given by the cost of the materials used in catalytic coatings applied to substrates that serve as electrodes and by their catalytic activity for the desired reaction. In the electrolysis of aqueous solutions, noble metals such as iridium, rhodium and ruthenium offer low overpotential and excellent catalytic activity for the oxygen evolution reaction, although their scarcity, combined with the resulting high costs, limits their large-scale application to economically generate high-purity hydrogen and oxygen. Therefore, it is important to explore alternative catalytic coatings with reduced amounts of noble metals and at low cost.

Furthermore, due to the fluctuating and intermittent behavior of renewable energy sources, electrolysers for the electrolysis of aqueous solutions must be adapted to dynamic operation, as many start and stop cycles of the system are possible. All of this causes polarity inversions that are harmful to the electrodes, whose life can be negatively affected, and their degradation can be accelerated.

Generally, these current inversions are avoided by using external polarization systems, but in a vision of containment and cost reduction of the entire process, the tendency is to completely eliminate the use of polarization devices with a consequent negative effect on life of the electrodes.

International patent application WO 2016/066544 A1 describes an electrode suitable for use in electrochlorination cells, especially an anode for the generation of active chlorine by electrolysis of seawater. The electrode comprises a titanium substrate, a first inner catalytic coating applied to the substrate containing a mixture of oxides of tantalum, ruthenium and iridium, an additional outer catalytic coating containing a mixture of oxides of titanium, ruthenium and at least one element selected from nickel, iron and cobalt.

International patent application WO 00/06800 A1 describes an anode for electrowinning cells having coating made of an oxygen barrier layer comprising at least one oxide selected from chromium, niobium and nickel oxide, an intermediate protective layer containing copper, or copper and at least one of nickel and cobalt, and/or oxides thereof, and an electrochemically active layer which is in one embodiment made of iron with at least one metal selected from nickel, copper, cobalt, aluminum and zinc.

International patent application WO 01/28714 A1 describes a cathode for chlor-alkali electrolysis comprising a conductive metal substrate and a first layer comprising a matrix with a catalytic powder dispersed therethrough. The matrix comprises a platinum group metal oxide or a mixture of a platinum group metal oxide and a valve metal oxide. The catalytic powder comprises support metal particles made of nickel, cobalt, iron, steel, stainless steel or copper, covered with an electrocatalytic metal coating made of ruthenium, iridium, osmium, platinum, palladium, rhodium or rhenium.

Among the various water electrolysis processes, the electrolysis of alkaline solutions is one of the best-known methods for the production of hydrogen, indeed it has advantages in terms of flexibility, availability and high purity of the hydrogen produced. However, to achieve a widespread use, hydrogen production by electrolysis of alkaline solutions requires energy improvements in terms of efficiency, safety, durability, reliability and, above all, a reduction in installation and operation costs.

In terms of process efficiency, low energy consumption, translated into a reduction in cell voltage, is essential for the market competitiveness.

The reduction of the aforementioned cell voltage can be largely achieved by using anodes and cathodes with catalytic coatings designed to facilitate the required electrochemical processes; these catalytic coatings play a very important role in improving the efficiency of the water electrolysis process for the production of hydrogen because they divert the path of the hydrogen and oxygen evolution reactions towards a lower activation energy.

In particular, the anodic coating represents a significant factor in achieving such voltage reduction.

The anode for the electrolysis of aqueous solutions typically uses nickel-based substrates, a material that is stable in aqueous solutions at high alkaline concentration; however, nickel-only electrodes show high potential and suffer from poor efficiency.

In the prior art, preferred anodes for the electrolysis of alkaline aqueous solutions include bare nickel electrodes, Raney nickel electrodes, and electrodes having catalytic coatings based on iridium oxides.

A bare nickel electrode consists only of a nickel substrate, in the form of a mesh (expanded, stretched, perforated, etc.). It can generally be easily produced at low cost but has a high overpotential for oxygen reaction resulting in slow kinetics. Electrodes with iridium-based catalytic coatings are produced through thermal decomposition; however, iridium is currently one of the least abundant noble metals resulting in a high price and difficulty in obtaining it in the large quantities needed for industrial-scale production processes. A further fundamental factor influencing the economic convenience of using electrodes activated with catalytic coatings based on noble metals concerns the operating life of the electrodes at high current densities.

Most noble metal-based catalytic coatings tend to suffer serious damages due to current inversions which can occur, among other things, in the event of disruptions to industrial plants; the flow of cathodic current with consequent raising of the electrode potential to high values can cause its uncontrolled dissolution. A partial resolution to this problem was obtained through the preparation of multilayer catalytic coatings comprising an intermediate layer applied directly on a Ni substrate and at least one active layer containing iridium. These compositions prove to be sufficiently resistant in the normal operating conditions of the system, however their durability is not optimal.

All this underlines the need to have a new anodic coating composition for industrial electrolytic processes, in particular for electrolytic processes with anodic evolution of oxygen, characterized by excellent catalytic activity at high current densities, with a lower overall cost in terms of raw materials and by a superior durability and resistance to accidental current inversions at the usual operating conditions.

The present invention aims to solve the problems described above and concerns an anode characterized by a low oxygen overvoltage and excellent resistance to repeated current reversals, even in the absence of external polarization systems, when the electrolysis is interrupted, combined with a low cost. The invention also concerns a method for producing it and an electrolyser that contains it.

### SUMMARY OF THE INVENTION

In the electrolytic process industry, the main driver for competitiveness is sought in the reduction of electrical voltage. The anodic coating represents a significant element in achieving this reduction; however, all modifications that lead to an improvement in the electrical voltage frequently result in a much weaker coating to current reversals that can occur accidentally in the event of disruptions to industrial plants.

A version of the anode coating, object of the present invention, solves the aforementioned problem by providing high robustness to the electrode, in terms of resistance to current reversals, while maintaining a good cell voltage.

The present invention provides an electrode, and in particular an electrode suitable for use as an anode for the generation of oxygen comprising a metal substrate having a catalytic coating, wherein said catalytic coating comprises at least an external layer containing nickel and at least one element selected from iridium, iron and calcium and at least one internal layer arranged between the metal substrate and said external layer.

One of the issues observed on the electrodes is the structural instability of the catalytic coatings during the current inversion phase when the electrodes suitable to be used as anodes are subjected to a cathodic current. The constant, and repeated, current inversions cause a progressive detachment of the catalytic coating leading to a progressive decay of the cell voltage.

The inventors have observed that the presence of an external layer allows the aforementioned problem to be solved by protecting the underlying internal layer, improving its mechanical stability in adverse operating conditions.

Said external layer has a thickness between 0.05-0.8 microns.

According to the present invention, the metal substrate can be any metal suitable for use as an electrode substrate for electrochemical processes, in particular, as a metal substrate for an anode to be used in electrolysis processes of aqueous solutions. In this case the most commonly used metal substrates can be chosen from nickel, nickel alloys, iron, iron alloys. The metal substrate is preferable a flat substrate, i.e. an overall flat component having two dimensions which are significantly larger than a third dimension. Preferably, the metal substrate is a mesh.

In a first aspect, the present invention relates to an electrode for gas evolution in electrochemical processes comprising a metal substrate provided with a catalytic coating, said catalytic coating comprising at least one external layer containing nickel and iron and at least one internal layer arranged between the metal substrate and said external layer.

The presence of an external layer containing nickel and iron has the advantage of significantly improving the tolerance of the electrode to current inversions, surprisingly bringing it to values very close to those characteristics of electrodes activated with high amounts of noble metals.

The inventors have surprisingly observed that said external layer containing nickel and iron performs a mechanical protection of the matrix of the underlying catalytic layer, also compacting the morphological defects of said internal layer.

Said morphological defects mainly derive from both the methods of treating the substrate to which said catalytic coating is applied and the methods of applying said catalytic coating to the substrate itself.

In a preferred embodiment of the electrode according to the present invention said external layer comprises iridium.

Thus, in a second aspect, the present invention relates to an electrode for gas evolution in electrochemical processes comprising a metal substrate provided with a catalytic coating, said catalytic coating comprising at least one external layer containing nickel and iridium and at least one internal layer arranged between the metal substrate and said external layer.

The inventors observed that the presence of an external layer containing nickel and iridium has the advantage of reducing the amount of noble metal of the underlying internal layer without a penalty of the catalytic activity for the oxygen evolution reaction being noticed.

According to an alternative embodiment of the electrode according to the present invention, said external layer comprises calcium.

Said external layer comprising nickel and at least one element chosen from iridium, iron and calcium seems to play the role of charge absorber during current inversions, indeed, thanks to this function the impact of the charge on the catalytic layer is substantially reduced and allows to observe a notable decrease in the consumption of the components of said internal layer, without penalties in terms of the potential and therefore in energy consumption.

According to a further embodiment of the electrode, the coating comprises a further external layer containing nickel, iron and calcium applied on said external layer containing nickel and iron and/or calcium.

The inventors have observed how the combination of said external layer with said further external layer is particularly efficient in protecting the metal substrate and the internal layer directly applied to said metal substrate and allows to obtain unexpectedly improved performances in terms of resistance to inversions.

In a further embodiment, said internal layer includes one or more metallic elements selected from the group which consists of cobalt, iridium, rhodium, nickel, platinum, lithium, strontium, calcium and manganese.

In some embodiments the coating comprises an additional internal layer comprising nickel deposited in direct contact with the substrate.

According to an embodiment of the electrode according to the present invention, said external layer contains 40-60% nickel and 40-60% iron by weight referred to the elements.

Preferably, the sum of nickel and iron is at least 90% by weight referred to the elements, more preferably at least 95% by weight of the external layer, i.e. other elements are only present at 10% by weight or less or at 5% by weight or less. In one embodiment, the external layer essentially consists of nickel and iron, i.e. the sum of nickel and iron is essentially 100% by weight with other elements being only present in trace amounts below 1% by weight.

According to an embodiment of the electrode according to the present invention, said external layer contains 50-95% nickel and 5-50% iridium by weight referred to the elements. Preferably, the sum of nickel and iridium is at least 90% by weight referred to the elements, more preferably at least 95% by weight of the external layer, i.e. other elements are only present at 10% by weight or less or at 5% by weight or less. In one embodiment, the external layer essentially consists of nickel and iridium, i.e. the sum of nickel and iridium is essentially 100% be weight with other elements being only present in trace amounts below 1% by weight.

The inventors have demonstrated that the presence of said external layer allows to obtain an excellent catalytic activity for the oxygen evolution reaction even at reduced noble metal loads thanks to the affinity of the elements present in the external layer for said oxygen evolution reaction.

The experimentation conducted by the inventors has shown that such formulations which include the presence of at least one external layer as described in the present invention provide an improvement in the oxygen overvoltage, also allowing the achievement of steady-state cell performance in an improved time compared to that generally observed with other formulations; furthermore, formulations of this type confer a resistance to current reversals several times higher than prior art formulations with a substantially reduced specific load of noble metal.

According to an embodiment of the electrode according to the present invention, said further external layer arranged on said external layer contains 20-50% of nickel, 20-50% of iron and 20-50% of calcium by weight based on the elements.

It is to be understood that the elements present in the catalytic coating can be in the form of metal or in the form of oxides. In the case of metal oxides, the concentration ranges given above refer to the metals.

In one embodiment said outer layer has a total metal load between 1 and 15 g/m². The inventors have found that the indicated weight compositions are capable of imparting high catalytic activity combined with excellent resistance to current reversals.

In a further embodiment said further external layer has a total metal load between 3 and 20 g/m².

In a further embodiment of the electrode according to the invention, the metal substrate comprises one or more metals selected from the group consisting of nickel, nickel alloys, iron and iron alloys. The preferred metal substrate is nickel, nickel alloys or iron alloys.

The electrode of the present invention can be used in several electrochemical applications. Due to its low oxygen overvoltage value, the electrode of the present invention is preferably used as an anode for oxygen evolution, especially as an anode in an electrolysis cell for the electrolysis of aqueous solutions and for the electrolysis of alkaline water.

In a further aspect, the present invention relates to a method for the preparation of an electrode for the evolution of gaseous products in electrolytic cells, for example for the evolution of oxygen in cells for the electrolysis of aqueous solutions, comprising the following steps:
a) application to a metal substrate of a solution comprising the precursors of said internal layer, subsequent drying at 50-100° C. and thermal decomposition at 450-600° C. for a time of 5 to 30 minutes;
b) repetition of step a) until the desired load is obtained;
c) application of a solution comprising the precursors of said external layer, subsequent drying at 50-100° C. and thermal decomposition at 450-600° C. for a time of 5 to 30 minutes;
d) repetition of step c) until the desired load is obtained.

A further embodiment comprising a further step preceding step a) consisting in the application of a solution comprising the precursors of said further internal layer in direct contact with the substrate, subsequent drying at 50-100° C. and thermal decomposition at 450-600° C. for a time of 5 to 30 minutes until the desired load is obtained.

A further embodiment comprising a further step subsequent to step d) consisting in the application of a solution comprising the precursors of said further external layer, subsequent drying at 50-100° C. and thermal decomposition at 450-600° C. for a time of 5 to 30 minutes until the desired load is obtained.

In certain embodiments, the drying steps are carried out at a temperature of 50-60° C. In other embodiments, the drying steps are carried out at a temperature of 70-90° C., preferably at around 80° C.

The above precursor solutions application be performed by brushing, spraying, dipping or other known techniques.

The precursors of said solutions comprising the precursors of said external layer and said further external layer can be chosen from the group consisting of nitrates and nitrosyl nitrates of metals and mixtures thereof.

The inventors have observed that the use of the specified precursors, in the described preparation conditions, favors the formation of a compact external layer, capable of protecting the underlying internal layer.

The precursors of said solutions comprising the precursors of said internal layer and further internal layer are compounds selected from the group consisting of chlorides, nitrates, nitrosyl nitrates of metals and mixtures thereof.

Under a further aspect, the invention relates to a cell for the electrolysis of aqueous solutions comprising an anodic compartment and a cathodic compartment, separated by an ion exchange membrane or a diaphragm wherein the anodic compartment is equipped with an electrode according to any one of the forms as described above used as an anode for oxygen evolution.

Under a further aspect, the invention relates to an electrolyser for the production of hydrogen by the electrolysis of aqueous solutions comprising a modular arrangement of electrolytic cells with the anodic and cathodic compartments separated by an ion exchange membrane or a diaphragm wherein the anodic compartment is equipped with an electrode according to any one of the forms as described above.

From a further aspect, the invention relates to a cell for the electrolysis of alkaline solutions comprising an anodic compartment and a cathodic compartment, separated by an ion exchange membrane or a diaphragm wherein the anodic compartment is equipped with an electrode according any one of the forms as described above used as an anode for oxygen evolution.

From a further aspect, the invention relates to an electrolyser for the production of hydrogen and oxygen starting from alkaline solutions comprising a modular arrangement of electrolytic cells with the anodic and cathodic compartments separated by ion exchange membranes or diaphragms, wherein the anodic compartment includes an electrode according to any one of the forms as described above used as an anode.

The following examples are included to demonstrate particular embodiments of the invention, the practicability of which has been extensively verified within the range of values claimed. It will be clear to the person skilled in the art that the compositions and techniques described in the following examples represent compositions and techniques which the inventors have found to work well in the practice of the invention; however, the person skilled in the art will also appreciate that in light of the present disclosure, various changes can be made to the various embodiments described still resulting in identical or similar results without departing from the scope of the invention.

### EXAMPLE 1

A first solution containing nickel and lithium precursors was prepared.

A second solution containing iridium, nickel and cobalt precursors was prepared.

A third solution containing nickel and iron precursors was prepared.

The first solution was applied to a nickel mesh by brushing. Drying was carried out at 40-100° C. for approximately 10 minutes, followed by a heat treatment between 40° and 500° C. The mesh was air cooled before applying the next coat. The internal layer was thus obtained in direct contact with the substrate.

Subsequently, the second solution was applied by brushing. After each coat, drying was carried out at 40-100° C. for approximately 10 minutes, followed by a heat treatment between 40° and 500° C. The mesh was air cooled each time before applying the next coat. The internal layer was thus obtained.

Subsequently, the third solution was applied by brushing. After each coat, drying was carried out at 40-100° C. for approximately 10 minutes, followed by a heat treatment between 40° and 500° C. The mesh was air cooled each time before applying the next coat. The outer layer was thus obtained.

The procedure is repeated until a total metal load of the outer layer of 10 g/m² is reached. The electrode thus obtained was identified as sample E1

### EXAMPLE 2

A first solution containing nickel and lithium precursors was prepared.

A second solution containing iridium, nickel and cobalt precursors was prepared.

A third solution containing nickel and iridium precursors was prepared.

The first solution was applied to a nickel mesh by brushing. Drying was carried out at 40-100° C. for approximately 10 minutes, followed by a heat treatment between 40° and 500° C. The mesh was air cooled before applying the next coat. The internal layer was thus obtained in direct contact with the substrate.

Subsequently, the second solution was applied by brushing. After each coat, drying was carried out at 40-100° C. for approximately 10 minutes, followed by a heat treatment between 40° and 500° C. The mesh was air cooled each time before applying the next coat. The internal layer was thus obtained.

Subsequently, the third solution was applied by brushing. After each coat, drying was carried out at 40-100° C. for approximately 10 minutes, followed by a heat treatment between 40° and 500° C. The mesh was air cooled each time before applying the next coat. The outer layer was thus obtained.

The procedure is repeated until a total metal load of the outer layer of 10 g/m² is reached. The electrode thus obtained was identified as sample E2.

### EXAMPLE 3

A first solution containing nickel and lithium precursors was prepared.

A second solution containing iridium, nickel and lithium precursors was prepared.

A third solution containing nickel and iron precursors was prepared.

The first solution was applied to a nickel mesh by brushing. Drying was carried out at 40-100° C. for approximately 10 minutes, followed by a heat treatment between 40° and 500° C. The mesh was air cooled before applying the next coat. The internal layer was thus obtained in direct contact with the substrate. Subsequently, the second solution was applied by brushing. After each coat, drying was carried out at 40-100° C. for approximately 10 minutes, followed by a heat treatment between 40° and 500° C. The mesh was air cooled each time before applying the next coat. The internal layer was thus obtained.

Subsequently, the third solution was applied by brushing. After each coat, drying was carried out at 40-100° C. for approximately 10 minutes, followed by a heat treatment between 40° and 500° C. The mesh was air cooled each time before applying the next coat. The outer layer was thus obtained.

The procedure is repeated until a total metal load of the outer layer of 10 g/m² is reached. The electrode thus obtained was identified as sample E3.

### EXAMPLE 4

A first solution containing iridium, nickel and lithium precursors was prepared.

A second solution containing nickel and iron precursors was prepared.

The first solution was applied to a nickel mesh by brushing. Drying was carried out at 40-100° C. for approximately 10 minutes, followed by a heat treatment between 40° and 500° C. The mesh was air cooled before applying the next coat. The internal layer was thus obtained. Subsequently, the second solution was applied by brushing. After each coat, drying was carried out at 40-100° C. for approximately 10 minutes, followed by a heat treatment between 40° and 500° C. The mesh was air cooled each time before applying the next coat. The outer layer was thus obtained.

The procedure is repeated until a total metal load of the outer layer of 10 g/m² is reached.

The electrode thus obtained was identified as sample E4.

### EXAMPLE 5

A first solution containing nickel and lithium precursors was prepared.

A second solution containing iridium, nickel and lithium precursors was prepared.

A third solution containing nickel and iron precursors was prepared.

A fourth solution containing nickel, iron and calcium precursors was prepared.

The first solution was applied to a nickel mesh by brushing. Drying was carried out at 40-100° C. for approximately 10 minutes, followed by a heat treatment between 40° and 500° C. The mesh was air cooled before applying the next coat. The internal layer was thus obtained in direct contact with the substrate. Subsequently, the second solution was applied by brushing. After each coat, drying was carried out at 40-100° C. for approximately 10 minutes, followed by a heat treatment between 40° and 500° C. The mesh was air cooled each time before applying the next coat. The internal layer was thus obtained.

Subsequently, the third solution was applied by brushing. After each coat, drying was carried out at 40-100° C. for approximately 10 minutes, followed by a heat treatment between 40° and 500° C. The mesh was air cooled each time before applying the next coat. The outer layer was thus obtained.

Subsequently, the fourth solution was applied by brushing. After each coat, drying was carried out at 40-100° C. for approximately 10 minutes, followed by a heat treatment between 40° and 500° C. The mesh was air cooled each time before applying the next coat. The further external layer was thus obtained.

The procedure is repeated until a total metal load of the further outer layer of 15 g/m² is reached.

The electrode thus obtained was identified as sample E5.

### COUNTEREXAMPLE 1

A first solution containing nickel and lithium precursors was prepared.

A second solution containing iridium, nickel and lithium precursors was prepared.

The first solution was applied to a nickel mesh by brushing. Drying was carried out at 40-100° C. for approximately 10 minutes, followed by a heat treatment between 40° and 500° C. The mesh was air cooled before applying the next coat.

Subsequently, the second solution was applied by brushing. After each coat, drying was carried out at 40-100° C. for approximately 10 minutes, followed by a heat treatment between 40° and 500° C. The mesh was air cooled each time before applying the next coat. The electrode thus obtained was identified as the CE1 sample.

### COUNTEREXAMPLE 2

A first solution containing nickel and lithium precursors was prepared.

A second solution containing iridium, nickel and cobalt precursors was prepared.

The first solution was applied to a nickel mesh by brushing. Drying was carried out at 40-100° C. for approximately 10 minutes, followed by a heat treatment between 40° and 500° C. The mesh was air cooled before applying the next coat.

Subsequently, the second solution was applied by brushing. After each coat, drying was carried out at 40-100° C. for approximately 10 minutes, followed by a heat treatment between 40° and 500° C. The mesh was air cooled each time before applying the next coat.

The electrode thus obtained was identified as the CE2 sample.

### COUNTEREXAMPLE 3

A first solution containing nickel and lithium precursors was prepared.

A second solution containing nickel and cobalt precursors was prepared.

The first solution was applied to a nickel mesh by brushing. Drying was carried out at 40-100° C. for approximately 10 minutes, followed by a heat treatment between 40° and 500° C. The mesh was air cooled before applying the next coat.

Subsequently, the second solution was applied by brushing. After each coat, drying was carried out at 40-100° C. for approximately 10 minutes, followed by a heat treatment between 40° and 500° C. The mesh was air cooled each time before applying the next coat. The electrode thus obtained was identified as the CE3 sample.

The samples of the examples and counterexamples described above were subjected to operational tests, under oxygen evolution, in a laboratory cell fed with 25% KOH at a temperature of 80° C.

Table 1 reports the initial anode potential (not corrected for the ohmic drop value) measured at a current density of 10 kA/m²; the reported values indicate that electrodes with a catalytic coating according to the present invention present a comparable, if not improved, anodic overvoltage compared to catalytic coatings known in the art.

TABLE 1

| | O₂ overpotential |
|---|---|
| Samples | (mV) a 10 kA/m² |
| E1 | 196 |
| E2 | 191 |
| E3 | 202 |
| E4 | 198 |
| E5 | 200 |
| CE1 | 210 |
| CE2 | 215 |
| CE3 | 250 |

An accelerated lifetime test with repeated current reversals was used to estimate the lifetime of the catalytic layer. The behavior of the electrodes after repeated current inversions is shown in Table 2.

The difference in the anode potential recorded after a series of current inversions compared to the initial anode potential is reported in millivolt (mV) in column 2 of Table 2, measured with respect to the normal hydrogen electrode (NHE) at a current density of 10 kA/m². Column 2 of Table 2 shows the potential difference in millivolt (mV) as compared to the normal hydrogen electrode (NHE). Column 3 shows the percentage of the Nobel metals residues after these current inversions as measured via X-ray Fluorescence (XRF) analysis. The Nobel metal content as measured before and after the test with the reversals. The reported values indicate that electrodes with a catalytic coating according to the present invention have excellent resistance to current reversals.

TABLE 2

| Samples | mv vs NHE | NM residue (%) |
|---|---|---|
| E1 | 18 | 98 |
| E2 | 15 | 99 |
| E3 | 10 | 96 |
| CE1 | 80 | 25 |
| CE2 | 60 | 42 |
| CE3 | 65 | 55 |

The previous description does not intend to limit the invention, which can be used according to different embodiments without departing from the purposes and whose scope is uniquely defined by the attached claims.

In the description and claims of the present application, the terms “comprises” and “contains” and their variants such as “comprising” and “containing” are not intended to exclude the presence of other elements, components or additional process steps.

Discussion of documents, records, materials, apparatus, articles, and the like is included in the text for the sole purpose of providing context to the present invention; however, it is not to be understood that this matter or part of it constituted general knowledge in the field relating to the invention before the priority date of each of the claims attached to this application.

1. An anode for oxygen evolution in electrochemical processes comprising a metal substrate and a catalytic coating wherein said metal substrate comprises one or more metals selected from the group consisting of nickel, nickel alloys iron and iron alloys and said catalytic coating comprises at least one external layer containing nickel and at least one element selected from iridium, iron and calcium and at least one internal layer arranged between the metal substrate and said external layer.

2. The anode according to claim 1, wherein said external layer contains iron.

3. The anode according to claim 1, wherein said external layer contains iridium.

4. The anode according to claim 1, the preceding claims wherein said internal layer arranged between the metallic substrate and said external layer comprises one or more metallic elements selected from the group consisting of cobalt, iridium, rhodium, nickel, platinum, lithium, strontium, calcium and manganese.

5. The anode according to claim 1, comprising a further internal layer in direct contact with the substrate containing nickel.

6. The anode according to claim 1, wherein said external layer contains 40-60% nickel and 40-60% iron by weight referred to the elements.

7. The anode according to claim 1, wherein said external layer contains 50-95% nickel and 5-50% iridium by weight referred to the elements.

8. The anode electrode according to claim 1, comprising a further external layer containing nickel, iron and calcium applied on said external layer containing nickel and iron and/or calcium.

9. A method for the production of anode as defined in claim 1 comprising the following steps:
a) applying to a metal substrate a solution comprising the precursors of said internal layer, subsequently drying at 50-100° C. and thermally decomposing at 450-600° C. for a time ranging from 5 to 30 minutes;
b) repeating stage a) until a desired load is obtained;
c) applying a solution comprising the precursors of said external layer, subsequently drying at 50-100° C. and thermally decomposing at 450-600° C. for a time comprised between 5 and 30 minutes;
d) repeating stage c) until a desired load is obtained.

10. The method according to claim 9 comprising a further step prior to step a) which consists in the application of a solution comprising the precursors of said further internal layer in direct contact with the substrate, subsequent drying at 50-100° C. and thermal decomposition at 450-600° C. for between 5 and 30 minutes until the desired load is obtained.

11. The method according to claim 9 comprising a further step subsequent to step d) which consists in the application of a solution comprising the precursors of said further external layer, subsequent drying at 50-100° C. and thermal decomposition at 450-600° C. for between 5 and 30 minutes until the desired load is obtained.

12. A cell for the electrolysis of aqueous solutions comprising an anodic compartment and a cathodic compartment wherein the anodic compartment is equipped with the anode according to claim 1.

13. The cell for the electrolysis according to claim 12, wherein said anodic compartment and said cathodic compartment are separated by a diaphragm or an ion exchange membrane.

14. An electrolyser for the production of hydrogen and oxygen starting from alkaline solutions comprising a modular arrangement of cells according to claim 13.
